(19) United States
(12) Patent Application Publication
(10) Pub. No.: US 2019/0163266 A1
(43) Pub. Date: May 30, 2019

(54) INTERACTION SYSTEM AND METHOD

(71) Applicant: SIEMENS AKTIENGESELLSCHAFT, München (DE)

(72) Inventors: Rebecca Johnson, München (DE); Asa MacWilliams, Fürstenfeldbruck (DE)

(21) Appl. No.: 16/315,241

(22) PCT Filed: Jun. 2, 2017
(86) PCT No.: PCT/EP2017/063415

§ 371 Date: Jan. 4, 2019

(30) Foreign Application Priority Data
Jul. 5, 2016 (DE) 10 2016 212 236.3

(51) Int. Cl. G06F 3/01

(52) U.S. Cl. CPC G06F 3/011; G06F 3/012; G06F 3/017

(57) ABSTRACT

The disclosure relates to an interaction system configured to be worn on the human body. The interaction system includes at least one gesture detection unit configured to be mounted in an arm region of a user, a binocular visualization unit for the positionally correct visualization of virtual objects in a visual field of the user, and a control unit for actuating the visualization unit. The gesture control is done intuitively with a motion and/or a rotation of the front arms. An input device, which may be unsuitable in an industrial environment, is thus not required. Due to the wearable character of the interaction system, the user may easily alternate between an actual maintenance procedure an industrial plant and an immersive movement in a virtual model of the industrial plant.

The present patent document is a § 371 nationalization of PCT Application Serial No. PCT/EP2017/063415, filed Jun. 2, 2017, designating the United States, which is hereby incorporated by reference, and this patent document also claims the benefit of German Patent Application No. DE 10 2016 212 236.3, filed Jul. 5, 2016, which is also hereby incorporated by reference.

### TECHNICAL FIELD

The disclosure relates to an interaction system and a method for the interaction of a user with a model of a technical system.

By way of example, such an interaction system and method find use in the automation technology sector, in production machines or machine tools, in diagnostic or service-assistance systems and when operating and servicing complex components, appliances and systems, particularly industrial or medical installations.

### BACKGROUND

The prior art has disclosed interaction systems which assist a user of technical installations in working through setup and maintenance work with the aid of an augmented situational representation. In the art, an augmented situational representation is also referred to as “augmented reality”. Here, a situation that is perceivable by the user is complemented with, or replaced by, computer-generated additional information items or virtual objects by way of a superposition or overlay.

In particular, the use of smart glasses is known. By way of example, a user equipped with smart glasses may observe an object of a technical system which, at the same time, is detected by an optical detection unit of the smart glasses. Within the scope of a computer-assisted evaluation of the optically detected object, additional information items or virtual objects relating to this object are available and may be selected and called by the user. By way of example, additional information items include technical handbooks or servicing instructions, while virtual objects augment the perceivable situation by way of an optical superposition or overlay.

By way of example, virtual action markers of an industrial robot, which serve the purpose of a collision analysis, are known; these are superposed on real industrial surroundings in the field of view of smart glasses in order to provide the user with an intuitive check as to whether the industrial robot may be positioned at an envisaged position in the envisaged surroundings on account of its dimensions or its action radius.

Selecting virtual objects and calling additional information items requires the detection of commands on the part of the user. In industrial surroundings, known input devices, such as, e.g., a keyboard, touchscreen, graphics tablet, trackpad, or mouse, which are tailored to a seated work position of a user in office surroundings, are already eliminated on account of the standing work position.

A further known approach relates to moving or tilting a wireless input device, (e.g., a flystick or wireless gamepad), in order to undertake the desired interaction. To this end, the user holds the input device in one hand; i.e., the user does not have both hands free.

A known provision of input elements on smart glasses is advantageous in that the user may have both hands free; however, triggering an input command by actuating such an input element is undesirable in many situations on account of continuous contact of the hands with working materials, for instance, in the case of a surgeon or an engineer.

A known optical detection of gestures, (for example, using Microsoft Kinect, Leap Motion or Microsoft HoloLens), is provided by one or more optical detection devices, which detect a posture of the user in three dimensions, (for example, by applying time-of-flight methods or structured-light topometry). The aforementioned methods likewise include the advantage of a hands-free mode of operation of the user but require use of optical detection devices in the surroundings of the user and hence require preparation of the work surroundings which is no less complicated.

In summary, currently known measures for interaction are implemented in non-contactless fashion, are implemented in unreliable fashion or are implemented with a use of input devices or optical devices for gesture detection that is inappropriate from a work-situational point of view.

### SUMMARY AND DESCRIPTION

By contrast, the present disclosure is based on the object of providing an interaction system with an intuitive and contactless detection of commands by gestures, which renders handling of input devices dispensable.

The scope of the present disclosure is defined solely by the appended claims and is not affected to any degree by the statements within this summary. The present embodiments may obviate one or more of the drawbacks or limitations in the related art.

The interaction system is configured to be worn on the human body and includes at least one gesture detection unit configured to be attached in an arm region of a user. The interaction system also includes a plurality of inertial sensors for detecting gestures, e.g., movement, rotation and/or position of arms of the user. A binocular visualization unit, which may be wearable in the head region of the user, serves for a positionally correct visualization of virtual objects in a field of view of the user. Furthermore, a control unit is provided for actuating the visualization unit, the control unit being provided to identify the gestures detected by the gesture detection unit and to process the interaction of the user with the objects that is to be triggered by the gestures of the user. The control unit is arranged on the body of the user, for example, integrated in the visualization unit or in one of the plurality of gesture detection units.

In contrast to known interaction systems, the interaction system is extremely mobile, or rather “wearable”. The gesture control is implemented intuitively by way of a movement and/or rotation of the forearms. There is no need for an input device, which may be inappropriate in industrial surroundings. On account of the wearable nature of the interaction system, the user may effortlessly alternate between actual servicing of an industrial installation and immersive movement in a virtual model of the industrial installation, for example, in order to view associated machine data or exploded drawings prior to or during the servicing of the industrial installation.

A particular advantage of the disclosure includes the fact that commercially available smart watches equipped with inertial sensors are usable as a wearable gesture detection unit.

Furthermore, the object is achieved by a method for the interaction of a user with a model of a technical system, wherein, without restriction to a sequence, the following acts are carried out in succession or at the same time: (1) detecting gestures produced by an arm position, arm movement, and/or arm rotation of the user by way of at least one gesture detection unit with a plurality of inertial sensors that is attached in an arm region of the user; (2) visualizing objects in positionally correct fashion in a field of view of the user by way of a binocular visualization unit; and (3) actuating the visualization unit, identifying the gestures detected by the gesture detection unit, and processing the interaction of the user with the objects that is to be triggered by the gestures of the user by way of a control unit.

According to an advantageous configuration, provision is made for two gesture detection units to be provided on a respective arm of the user. Selectively, a selection gesture, range selection gesture, a movement gesture, a navigation gesture, and/or a zoom gesture may be assigned to one of the two gesture detection units and a confirmation gesture may be assigned to the other gesture detection unit by way of the interaction system—e.g., by way of the control unit or by way of the respective gesture detection unit or by way of the control unit in conjunction with both gesture detection units.

According to an advantageous configuration, provision is made for the gesture detection unit to moreover provide myoelectric and/or mechanical sensors for detecting the gestures produced by arm movements of the user. Myoelectric sensors detect a voltage produced as a consequence of biochemical processes in the muscle cells. By way of example, mechanical sensors detect mechanical surface tension changes or the actions of force on the surface of the body as a consequence of the arm movements of the user. These measures provide a refinement of the reliability of the gesture control and, for example, finger movements may also be detected.

According to an advantageous configuration, the visualization unit is actuated in such a way that the representation of virtual objects does not exclusively determine the field of view of the user, and so the representation of the virtual objects thus becomes visible to the user in addition to the real surroundings. Using such an augmented situational representation or “augmented reality”, the real surroundings that are optically perceivable by the user are complemented by way of a superposition by the virtual objects that are produced by the interaction system. Such a configuration lends itself in cases in which a superposition of virtual objects, for example, an indication arrow on a machine component to be serviced, in addition to the reception of the real surroundings assists with the understanding of the real surroundings.

According to an alternative configuration, the visualization unit is actuated in such a way that the real surroundings are replaced by way of an overlay by the virtual objects produced by the interaction system. Such a configuration lends itself in cases in which a greater degree of immersion in the virtual situational representation may be offered to the user, e.g., in which a superposition with the real surroundings would be a hindrance to the understanding of the virtual representation.

According to an advantageous configuration, provision is made for one or more actuators to be provided in at least one gesture detection unit and/or in the visualization unit, by which actuators an output of feedback that is haptically perceivable by the user may be prompted by way of the control unit. By way of example, an unbalanced-mass motor for producing vibrations serves as an actuator. This feedback is implemented in the head region—should the actuators be localized in the visualization unit—or in a respective arm region—should the actuators be localized in a gesture detection unit. Such feedback will be triggered in the case of certain events, for example, marking or virtually grasping an object or when the end of a list of a menu is reached.

According to a further advantageous configuration, the interaction system has at least one marker for determining spatial coordinates of the interaction system. By way of example, one or more markers may be provided on the at least one gesture detection unit, on the visualization unit and/or on the control unit. This measure permits use of the interaction system in conventional virtual surroundings, in which a tracking system (e.g., an optical tracking system) is used. In one embodiment, infrared cameras detect the spatial coordinates of the at least one marker and transmit these to the control unit or to an interaction-system-external control unit. Such a development additionally assists with the determination of the location of the user's field of view and of the user themselves, in order to provide a positionally correct visualization of objects in the field of view of the user.

A further advantageous configuration provides for one or more interfaces that are provided in the control unit for the purposes of communicating with at least one further interaction system and/or at least one server. This measure forms the basis of an interaction system group having at least one interaction system, possibly with the involvement of further central computers or servers. Using an interaction system group, a number of cooperating engineers may, for example, carry out a design review on a model of an industrial installation within the meaning of “collaborative working”.

### BRIEF DESCRIPTION OF THE DRAWINGS

Further exemplary embodiments and advantages are explained in more detail below on the basis of the drawing.

FIG. 1 depicts an example of a schematic structural illustration of a user operating the interaction system.

### DETAILED DESCRIPTION

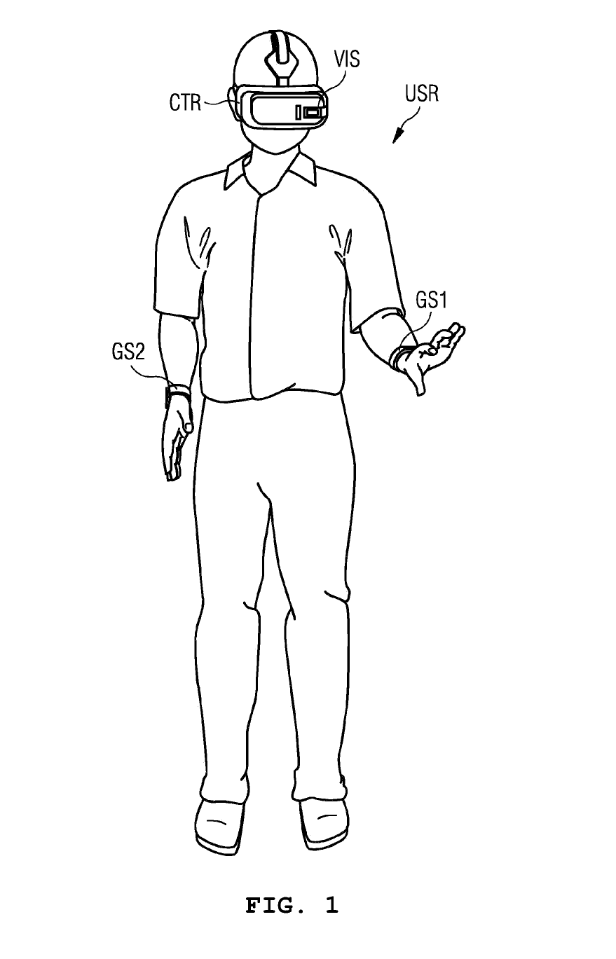

FIG. 1 depicts a user USR with a visualization unit VIS that is worn on the body of the user USR, a control unit CTR and two gesture detection units GS1, GS2, which are detachably attached to a respective arm region of the user USR, for example, by way of an armband attached in the region of the wrist.

Software made to run on the control unit CTR calculates virtual three-dimensional surroundings or virtual three-dimensional scenery, which is displayed to the user by way of the visualization unit VIS that is connected to the control unit CTR. The scenery includes or represents a model of a technical system.

Each gesture detection unit GS1, GS2 includes a plurality of inertial sensors (not illustrated), optionally also additional optical sensors (not illustrated), magnetometric sensors, gyroscopic sensors, mechanical contact sensors and/or myoelectric sensors.

While the inertial sensors of the gesture detection units GS1, GS2 detect a movement of a respective arm of the user USR—analogously to the above-described detection of the head movement—the myoelectric sensors serve to detect a voltage as a consequence of biochemical processes in the muscle cells. The additional measurement results of the myoelectric sensors are used for refining movement data acquired with the aid of the inertial sensors according to one configuration. The gesture detection units GS1, GS2 and the control unit CTR may interchange data in wireless fashion.

A gesture is deduced in the control unit CTR on the basis of the detected arm movements of the user USR. The interaction system interprets this gesture as an input command, on account of which an operation is carried out on the basis of the input command.

The gestures may be produced in free space, by way of which the control commands and/or selection commands are triggered. The gestures include one or more of the following: a swiping movement performed with one hand along a first direction; a swiping movement performed with one hand along a direction that is opposite to the first direction; a movement of an arm along a second direction extending in perpendicular fashion in relation to the first direction; a movement of an arm along a direction that is opposite to the second direction; a pronation or supination of an arm; an abduction or adduction of an arm; an internal and external rotation of an arm; an anteversion and/or retroversion of an arm; a hand movement, whose palm points in the first direction; and/or a hand movement, whose palm points in the direction that is opposite to the second direction; and all further conceivable gestures in combination with the aforementioned movements. The first or second direction may extend in the dorsal, palmar or volar, axial, abaxial, ulnar or radial direction.

The control unit CTR analyzes the movement patterns detected by the gesture detection unit GS1, GS2 and classifies the movement patterns as gestures. Then, an interaction of the user USR with the virtual objects that is to be triggered is determined from the gestures of the user USR. The control unit CTR actuates the visualization unit VIS in such a way that the interaction of the user USR with the objects is presented in a manner visible to the user.

The visualization unit VIS may include a plurality of inertial sensors (not illustrated). The plurality of inertial sensors may have 9 degrees of freedom, which are also referred to as “9DOF” in the art. The inertial sensors each supply values for a gyroscopic rate of rotation, acceleration and magnetic field in all three spatial directions in each case. A rotation of the head is detected by way of a measurement of the rate of rotation. Translational head movements of the user USR are detected by way of measuring the acceleration. Measuring the magnetic field serves predominantly to compensate a drift of the gyroscopic sensors and therefore contributes to a positionally correct visualization of virtual objects in the field of view of the user. This positionally correct visualization of virtual objects in the field of view of the user is also known as “head tracking” in the art.

At least one inertial sensor (not illustrated) of the aforementioned type may also be provided in the gesture detection unit GS1, GS2, wherein the inertial sensor may have 9 degrees of freedom.

In an advantageous development, the head tracking may additionally be improved by evaluating an optical detection unit or camera (not illustrated), which is provided in the visualization unit VIS, wherein changes in the surroundings of the user USR detected by the detection unit as a consequence of the head movement are evaluated.

The scenery calculated by the control unit CTR is consequently configured to a change in perspective of the user USR that is detected by the head position, rotation and movement.

The user USR may orient themselves and move within the scenery by way of appropriate head movements. To this end, spatial coordinates of their head position are matched to their own perspective or “first-person perspective”.

Furthermore, the user USR may virtually detect and move two-dimensional or three-dimensional objects or handling marks in the scenery. This assists a so-called “virtual hands” concept. A selection or handling of objects in the scenery precedes a respective processing operation, which includes a change of parameters, for example. Processing, selecting, or handling of objects may be visualized by way of a change in the size, color, transparency, form, position, orientation or other properties of the virtual objects.

Finally, the scenery itself may also be adapted as a consequence of certain processing operations or handling marks, for example within the scope of a change in perspective or presentation, or “rendering”, of the scenery, which has as a consequence that the latter is presented in larger, smaller, distorted, nebulous, brighter or darker fashion.

The virtual scenery is configured to the needs of the user USR in relation to a speed of the presentation, for example in the case of a moving-image presentation of repair instructions.

An interaction of the user USR with the objects is optionally implemented with the aid of text-based or symbol-based menu displays and with the aid of arbitrary control elements, for example, a selection of a number of possibilities from a text-based menu.

Finally, a switchover between real, virtual, and augmented presentation is also possible, particularly if the binocular visualization unit VIS is configured to detect the real surroundings by way of a camera and the camera image is superposable in its correct position into the field of view of the user USR.

Furthermore, various modes of interaction are providable, for example, to the extent of the left arm of the user USR causing a movement within the scenery while the right arm serves to select and handle virtual objects. Alternatively, the right arm is used for handling the objects and the left arm is used for changing the properties of a selected object. These and further modes of interaction may be selected or changed in turn by way of an input of gestures.

According to one configuration, optical feedback for the user USR in relation to virtual events is provided. By way of example, haptic feedback is advantageous in the following situations: the user USR “touches” a virtual object or changes into another interaction mode for a certain hand, (e.g., camera movement, movement of a virtual hand), by way of a suitable gesture. Furthermore, haptic feedback may also be triggered by calling a selection option.

In a configuration according to FIG. 1, the control unit CTR and the visualization unit VIS have an integral design, for example in the form of a mobile terminal with display, which is fastened to the head of the user USR by way of a suitable attachment and which is held at a definable distance from the field of view of the user USR, when necessary using an optical unit including lenses, mirrors, or prisms. Alternatively—depending on the use surroundings—head-mounted displays or smart glasses are also advantageous for an implementation of a configuration of the disclosure.

The interaction system is particularly suitable for use in industrial surroundings. This basic suitability becomes even clearer from further advantageous developments of the disclosure.

According to an advantageous configuration, the control unit CTR and at least parts of the visualization unit VIS are integrated in a protective helmet of a worker or in a surgical loupe holder of a surgeon. In this way, constant availability of the interaction system in the work surroundings is provided. When necessary, the worker or surgeon may move an imaging part of the visualization unit VIS (e.g., a binocular display, a mirror arrangement, or a lens arrangement) into their field of view by way of a pivoting movement. After assessing a virtual model of a machine to be serviced or after assessing a human body to be treated, the imaging part may be pivoted back so as to carry out the previously simulated, demonstrated and/or explained process in real life. In one variant of this embodiment, the pivoting movement or else translation movement for using the imaging part is also carried out in motor-driven fashion by way of gesture control, (e.g., prompted by the gesture detection unit GS1, GS2), in order to avoid the contamination of the imaging part as a consequence of contact on account of a manual pivoting movement by a worker or surgeon.

According to a further configuration, provision is made for the visualization unit VIS to be realized as a portable communications unit, for example as a smartphone. In this way, the user may switch from a conventional interaction with their smartphone and smartwatch to a VR interaction, in which the smartphone is placed in front of the eyes and presents stereoscopic virtual surroundings.

The “wearable” interaction system (e.g., configured to be worn on the human body) includes at least one gesture detection unit attached in an arm region of a user, a binocular visualization unit for positionally correct visualization of virtual objects in a field of view of the user, and a control unit for actuating the visualization unit. The gesture control is implemented intuitively with a movement and/or rotation of the forearms. Consequently, there is no need for an input device, which may be inappropriate in industrial surroundings. On account of the wearable nature of the interaction system, the user may effortlessly alternate between actual servicing of an industrial installation and immersive movement in a virtual model of the industrial installation.

Although the disclosure has been illustrated and described in detail by the exemplary embodiments, the disclosure is not restricted by the disclosed examples and the person skilled in the art may derive other variations from this without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. An interaction system configured to be worn on the human body, the interaction system comprising:
at least one gesture detection unit configured to be attached in an arm region of a user, the at least one gesture detection unit having a plurality of inertial sensors for detecting gestures produced by one or more of an arm position, an arm movement, or an arm rotation of the user;
a binocular visualization unit for a positionally correct visualization of objects in a field of view of the user; and
a control unit for actuating the visualization unit, for identifying the gestures detected by the gesture detection unit, and for processing an interaction of the user with the objects to be triggered by the gestures of the user.

2. The interaction system of claim 1, wherein the at least one gesture detection unit comprises two gesture detection units provided on a respective arm of the user, and
wherein, selectively, one or more of a selection gesture, a range selection gesture, a movement gesture, a navigation gesture, or a zoom gesture is assignable to one of the two gesture detection units and a confirmation gesture is assignable to the other gesture detection unit by the interaction system.

3. The interaction system of claim 1, wherein the at least one gesture detection unit comprises one or more of myoelectric sensors, magnetic sensors, or mechanical sensors for detecting the gestures produced by the arm movements of the user.

4. The interaction system of claim 1, wherein one or both of the at least one gesture detection unit and the visualization unit comprise one or more actuators for outputting feedback that is haptically perceivable by the user.

5. The interaction system of claim 1, wherein the objects visualized by the visualization unit complement or replace optically perceivable surroundings by a superposition or overlay.

6. The interaction system of claim 1, further comprising:
at least one marker for determining spatial coordinates of the interaction system.

7. The interaction system of claim 1, wherein the control unit comprises an interface for communicating with at least one further interaction system, at least one server, or a combination thereof.

8. (canceled)

9. A method for an interaction of a user with a model of a technical system, the method comprising:
detecting gestures produced by one or more of an arm position, an arm movement, or an arm rotation of the user by at least one gesture detection unit with a plurality of inertial sensors attached in an arm region of the user;
visualizing objects in positionally correct fashion in a field of view of the user by a binocular visualization unit; and
actuating the binocular visualization unit, identifying the gestures detected by the gesture detection unit, and processing the interaction of the user with the objects to be triggered by the gestures of the user by a control unit.

10. The method of claim 9, wherein the at least one gesture detection unit comprises two gesture detection units provided on a respective arm of the user, and
wherein, selectively, one or more of a selection gesture, a range selection gesture, a movement gesture, a navigation gesture, or a zoom gesture is assigned to one of the two gesture detection units and a confirmation gesture is assigned to the other gesture detection unit.

11. The method of claim 9, wherein the objects that are visualized by the visualization unit complement or replace optically perceivable surroundings by way of a superposition or overlay.

12. (canceled)

13. The method of claim 9, further comprising:
alternating, by the user, between servicing an industrial installation and the model of the technical system.

14. The method of claim 9, further comprising:
alternating, by the user, between performing a medical treatment and the model of the technical system.

15. The interaction system of claim 2, wherein the two gesture detection units comprise one or more of myoelectric sensors, magnetic sensors, or mechanical sensors for detecting the gestures produced by the arm movements of the user.

16. The interaction system of claim 2, wherein one or both of the two gesture detection units and the visualization unit comprise one or more actuators for outputting feedback that is haptically perceivable by the user.

17. The interaction system of claim 2, wherein the objects visualized by the visualization unit complement or replace optically perceivable surroundings by a superposition or overlay.

18. The interaction system of claim 2, further comprising:
at least one marker for determining spatial coordinates of the interaction system.

19. The interaction system of claim 2, wherein the control unit comprises an interface for communicating with at least one further interaction system, at least one server, or a combination thereof.
